(19) United States
(12) Patent Application Publication
(10) Pub. No.: US 2008/0272031 A1
(43) Pub. Date: Nov. 6, 2008

(54) SCREENING/DEDUSTING APPARATUS

(76) Inventor: Matthias Coppers, Essen (DE)

Correspondence Address: K.F. ROSS P.C., 5683 RIVERDALE AVENUE, SUITE 203 BOX 900, BRONX, NY, 10471-0900, US

(21) Appl. No.: 12/114,862

(22) Filed: May 5, 2008

(30) Foreign Application Priority Data
May 4, 2007 (DE) 102007021004.5

(51) Int. Cl. B07B 9/00

(52) U.S. Cl. 209/20

(57) ABSTRACT

A screening apparatus has a generally closed housing and partitions in the housing forming a fine-particle passage having an upstream end and a downstream end and a coarse-particle passage having an upstream end and a downstream end. A screen at the upstream ends is fed particulate material including dust and fine and coarse particles such that the coarse particles are diverted to the coarse-particle passage and the fine particles and dust to the fine-particle passage. A air-classifier in the fine-particle passage dedusts particles therein.

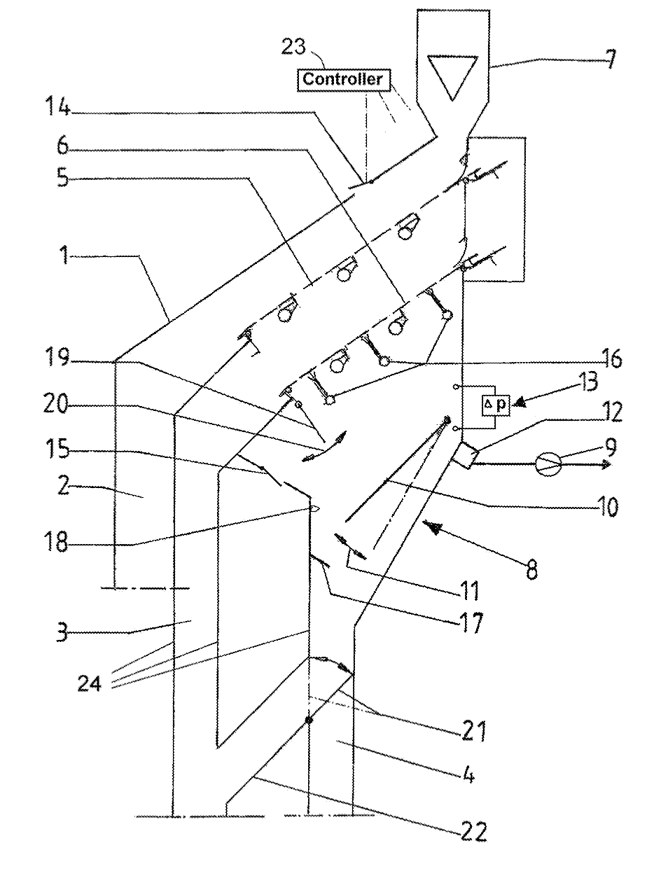

### FIELD OF THE INVENTION

The present invention relates to an apparatus for separating particulate material into different grades. More particularly this invention concerns such an apparatus that also dedusts the particulate material.

### BACKGROUND OF THE INVENTION

A standard screening apparatus has a housing, at least one screen therein, means for feeding mixed-grade particulate material to an upstream side of the housing, a screen, at least one coarse-particle separator that removes the coarse grade or fraction passing through the screen, and a fine-particle separator that removes the fine-particle fraction passing by the screen.

Such a screening apparatus are known according to prior art in single-screen or multiple-screen models. Furthermore, so-called separators are known, by means of which a very fine separation and dedusting is accomplished. In complex materials, in which a dedusting of the material is required, the known devices pose problems. If, for example, a de-dusting of fine salt is to take place, in which a particle size ranges 0-2 mm and final dust content (100 μm) is to be less than 5%, this is possible only at great difficulty using the known devices.

In dedusting below 200 μm it is very difficult to treat large volumes of material. Due to the low specific screening outputs, a large screening apparatus must have a multiple-screen setup. Such a screening apparatus is very expensive. Separation using a sifter is also disadvantageous, since often a very large particle-size distribution of the processing material is present, and a high energy consumption would be required for its transport and separation. Therefore, according to the prior art, this is accomplished either using a standard a screening apparatus and separating out the dust by suctioning it off in the output stages, i.e. in the fine-particle compartment, where, however, as little as possible of the fine-particle should be aspirated. These goals are contrary to each other, since with a high suction significant amounts of fine material are aspirated, and with low suction large amounts of dust remain in the material. Furthermore, separating dust and fine material alone by suctioning it off cannot be accomplished because an additional separation of the bulk material would then be required. The separation of dust by means of a sifter with, for example, rotating components, is also problematic, because the very material that is coarser than approximately 2 mm must be separated in a separate downstream screening apparatuses for the protection of the separator. With a positive flow separator, is known, for example, from DE 35 27 179.

### OBJECTS OF THE INVENTION

It is therefore an object of the present invention to provide an improved screening apparatus.

Another object is the provision of such an improved screening apparatus that overcomes the above-given disadvantages, in particular that is which can also dedust the separated fractions of the incoming particulate material.

### SUMMARY OF THE INVENTION

A screening apparatus has according to the invention a generally closed housing and partitions in the housing forming a fine-particle passage having an upstream end and a downstream end and a coarse-particle passage having an upstream end and a downstream end. A screen at the upstream ends is fed particulate material including dust and fine and coarse particles such that the coarse particles are diverted to the coarse-particle passage and the fine particles and dust to the fine-particle passage. An air classifier in the fine-particle passage dedusts particles therein.

By means of combining a separator having at least one, or even multiple screens and an air classifier in the fine-particle passage, a compact and energy-efficient classification is possible. The advantages of the material separation and quantity reduction by means of screening are utilized, while the dedusting by means of the air classifier integrated in the fine-particle process is enabled using relatively low air quantities.

For this purpose, the air quantity advantageous for accommodating fine-particle screening may be simultaneously utilized for screening. According to the invention the screening apparatus has a substantially closed housing, the fine particles being discharged at a lower outlet after being dedusted in a separation zone in a defined manner.

According to the invention the screening apparatus may have at least one screen. However, it is also possible to have multiple screens. In a combination of screening apparatus and air classifier, different configurations are possible. For example, it is possible to install the screening apparatus and the air classifier in a stationary housing, wherein only the screen mesh or cloth is moved. As an alternative, the screening apparatus may also be displaced with the mesh, and the fine-particle passage can be fixed relative to the air classifier. It is also possible to displace the screening apparatus, including the air classifier, in an oscillating manner. Preferably, the air classifier extends the entire working width of the fine-particle passage of the screening apparatus. Preferably the particle feeder extends the entire working width of the horizontally elongated screen.

For this purpose, the screening apparatus is equipped with a particle feeder for the full-width spreading of the material onto the screen, and therefore into the separator.

According to the invention an extracting fan is connected to the fine-particle passage of the housing as an integral part of the air classifier by means of which the dust fraction of the fine particles can be aspirated. The aspirated dust can be fed to a cyclone or the like for separation of the dust from the air entraining it.

Preferably, a flow-control flap is provided between the screen and the extracting fan for adjusting the air velocity in the fine-particle passage and thereby controlling the air classification. This flow-control flap serves for adjusting the classifying air velocity on one hand, and ensures a full-width distribution of the material that is as uniform as possible, on the other hand, the fine-particle all flowing through the screen and to the separator zone. Preferably, the flow-control flap may be deflected above the extracting fan, and below the screen at a housing wall so that the sifting air velocity can be adjusted by pivoting the flow-control flap open or closed, a uniform distribution of the fine-particle flow delivered by the screen being achieved with the fine-particle flow impinging on the flow-control flap, and being distributed by same in a largely uniform manner.

Preferably, the extracting fan has an adjustable baffle for adjusting the amount of suctioning air. Adjustment of this baffle controls the amount of air can be adjusted, for example, for suctioning velocities of 10 to 40 m/s. The speed of the classifying air is controlled by the flow-control flap occurs, to be for example in the range of 0.5 to 50 m/s.

In addition for calibrating the apparatus a differential pressure-measuring system is installed in the housing, with a first pressure sensor in the descending flow direction of the screen material upstream of the flow-control flap, and a second pressure sensor downstream of the flow-control flap.

Depending on the bulk material, the user can determine gas volume flow, the gas velocity, and the separating particle size by means of the differential pressure measurement in connection with the respective defined cross-section. Once the adjustment has once been made for a certain bulk material, no other changes are necessary.

In addition according to the invention vent openings are provided in a housing wall above the screen. Such openings above the screen in the housing wall promote transport of the fine particles, since the air flowing in through the vent openings and pulled out by the extracting fan, improves transport of the fine particles through the screen.

Furthermore, a vent flap is provided below the screen in the housing wall. When the amount of air flowing through the screen cloth is too great in to allow flow through the screen, the vent can be opened in order to supply additional air that does not have to flow through the screen.

The screen is equipped with a cleaning device, for instance an array of small hammer-like elements that vibrate the screen and prevent it from clogging. Similarly, compressed air nozzles are arranged below the screen cloth that direct jets of compressed air up through the screen in counterflow to the downwardly moving particles. This compressed air flowing through the screen cloth in counterflow from below cleans the screen and also assists in classification and separation of the fractions of the bulk particulate material.

Furthermore, baffles are provided in the fine-particle passage by means of which the fine particles are dispersed. This fine-particle passage has baffles that the fine particles impinge upon so that it they are even better dispersed. In addition or alternatively air-supply nozzles are provided in the fine-particle passage, which are directed transversely across the fine-particle passage at the intake of the extracting fan, this ensures that the light dust particles are pushed over and aspirated by the extractor while the heavier particles drop and can move out of the apparatus. This additional air supply, which can be constituted by a horizontal row of horizontally directed jets, improves separation of the bulk material in the fine-particle passage. Furthermore at least one deflector is provided below the downstream face of the screen, by means of which material guiding is influenced in the separation zone. Such an adjustable deflector optimally guides the fine particles in the separation zone.

In accordance with the invention the fine-particle passage is equipped with a pivotal guide baffle below the separation zone, for segregating the fine-particle passage from the coarse-particle passage in a first position, and for connecting the fine-particle passage to the coarse-particle passage in a second position so that the coarse and fine-particle flows are combined.

Depending on the application of the screening apparatus it is possible to discharge the separated material flows of coarse and fine-particle separately. In many applications, however, separation of coarse- and fine particles is necessary only to get out the dust. Subsequently, the two material flows may be recombined so that a dust-free mixed material is the result. For this purpose, the pivotal guide baffle is provided to close a bypass or connecting passage or conduit between the fine-particle passage and the coarse-particle passage in a first position, and opens this conduit in a second position so that the dedusted fine particles are fed to the coarse-particle passage together with the coarse particles.

### BRIEF DESCRIPTION OF THE DRAWING

The above and other objects, features, and advantages will become more readily apparent from the following description, reference being made to the accompanying drawing whose sole FIGURE is a largely schematic side view of the apparatus according to the invention.

### SPECIFIC DESCRIPTION

As seen in the drawing, a screening apparatus has a substantially closed housing 1 subdivided internally by parallel partitions 24 into a coarse-particle passage 2, a medium-grade passage 3, and a fine-particle passage 4. The passage 2, 3, and 4 have upper upstream ends, lower downstream ends, and are also elongated horizontally perpendicular to the plane of the view. Two different screens 5 and 6 form angled upper portions of the partitions 24. These screens 5 and 6 are provided with drives that oscillate and/or reciprocate them and even with hammer systems that strike them repeatedly during operation as is known in the art.

A feeder or supply 7 drops an ungraded mixture of particles into a top side of the housing 1 so that it falls first on the upper end of the downwardly angled coarse-mesh screen 5, whose mesh size is such that everything with a particle size smaller than 2 mm falls through it. This feeder 7 extends a full width (perpendicular to the view plane) of the housing 1 so that the screens 5 and 6, which also extend the full width, are evenly covered with the incoming particulate material. The bigger particles greater than 2 mm are held up by the screen 5 and move downward in the passage 2 to exit from its lower outlet end. The particles smaller than 2 mm pass through the screen 5 and drop onto the screen 6 whose mesh size is such that particles that are greater than 1 mm slide downward along this screen 6 and move downward in the medium passage 3 to exit from its lower outlet end.

The fine fraction thus passes through the screen 6 and drops down in the fine passage 4. According to the invention an air classifier 8 is integrated into the fine-particle passage 4. The fine material is dedusted by means of this air classifier 8 by removing dust particles, for example, of a particle size below 200 μm. A extracting fan 9 is connected to the housing 1 in the fine-particle passage 4 as an integral part of the air classifier 8, by means of which the dust content of the fine-particle is aspirated. A flow-control flap 10 is arranged between the screen 6 and the extracting fan 9 for adjusting the air velocity in the passage 4. This flow-control flap 10 is hinged on the housing wall above the extracting fan 9 and below the screen 6 so that pivoting in the direction of arrow 11 is possible. Furthermore, the extracting fan 9 has an adjustable intake opening 12 for further adjusting the amount of suctioned air.

A differential pressure measuring device 13 with upstream and downstream pressure sensors flanking the flow-control flap 10 is coupled via a controller 23 to the evacuating fan 9 device in the downward flow direction of the screened material. In this manner, a differential pressure measurement in connection with defined cross-sections of the screening apparatus, and therefore a determination of the gas volume flow, the gas velocity, and particle size is enabled.

Further, ventilation openings 14 are provided in a housing wall above the screens 5 and 6. By means of these ventilation openings 14 the fine-particle amount can be increased, since air is drawn in through them by the extracting fan 9 and which is puled through the screens 5 and 6 in order to therefore increase the amount of fine-particle passing through the screens 5 and 6.

In addition a vent flap 15, which opens to the outside, is provided in the housing wall below the screen 6. It is opened when the suctioned amount of air is too much to flow through the screens 5 and 6.

Each screen 5 and 6 is preferably provided with a cleaning device, such as hammers or the like. Additional compressed air nozzles 16 are also arranged below the screen 6, by means of which compressed-air jets are directed at the bottom face of the screen 6 to flow through it counter to the downwardly moving particles. Further, the screened material is dispersed by means of this supplied compressed air.

Furthermore, baffles 17 are arranged in the fine-particle passage 4 and serve for the improved dispersing of the discharged fine material. Finally, air supply nozzles 18 are provided near the end of the fine-particle passage 4 closer to the screen 6 and are directed cross-wise into the fine-particle passage 4 and across the fine-particle flow passing down through the screen 6. In this manner, the fine material is further dispersed.

Furthermore, a deflector 19 is arranged below the downstream face of the screen 6, by means of which the material flow is influenced in the direction of the separation zone. The deflector can be adjusted corresponding to arrow 20.

A pivotal baffle 21 is provided in the fine-particle passage 4 below the separation zone and can move between the solid-line position diverting all flow from the fine-particle passage 4 through a bypass passage 22 into the medium passage 3, and the dashed-line position segregating the passage 3 and 4 from each other and blocking off the bypass passage 22. In the solid-line position the medium fine fractions are combined.

The dual-purpose apparatus illustrated in the drawing makes it possible, for example, to free a bulk material with a grain band of 0 to 2 mm of dust (dust particles <0.1 mm) so that the bulk material exits the apparatus in a nearly dust-free condition.

The mechanical cost is relatively low, as is the energy input and energy consumption during operation of the dual-purpose apparatus.

The invention is not limited to the illustrated embodiment, but is variable within the scope of disclosure. All novel individual and dual-purpose characteristics disclosed in the description and/or drawing are considered essential to the invention.

I claim:

1. A screening apparatus comprising:
a housing;
partitions in the housing forming a fine-particle passage having an upstream end and a downstream end and a coarse-particle passage having an upstream end and a downstream end;
a screen at the upstream ends;
feed means for supplying particulate material including dust and fine and coarse particles to the screen such that the coarse particles are diverted to the coarse-particle passage and the fine particles and dust to the fine-particle passage; and
air-classifying means in the fine-particle passage for dedusting particles therein.

2. The apparatus defined in claim 1 wherein the upstream ends are above the respective downstream ends and passages and screen are horizontally elongated, the feed means supplying particles to the screen along its entire horizontal length.

3. The apparatus defined in claim 1 wherein the air-classifying means includes an extracting fan downstream of the screen and opening into the fine-particle passage.

4. The apparatus defined in claim 2, further comprising
control means including a flow-control flap in the fine-particle passage upstream of the extracting fan and adjustable to regulate flow in the fine-particle passage.

5. The apparatus defined in claim 4 wherein the control means includes an adjustable-size intake opening for regulating gas volume moved by the extracting fan.

6. The apparatus defined in claim 4 wherein the control means includes pressure sensors in the fine-particle passage upstream and downstream of the flow-control flap for monitoring pressure in the fine-particle passage.

7. The apparatus defined in claim 3 wherein the air-classifying means includes a vent opening in the housing upstream of the screen, whereby the extracting fan draws ambient air in through the event opening and through the screen.

8. The apparatus defined in claim 7 wherein the air-classifying means includes another vent opening in the housing downstream of the scream.

9. The apparatus defined in claim 8 wherein the other vent opening is upstream of the extracting fan.

10. The apparatus defined in claim 1, further comprising means for cleaning the screen.

11. The apparatus defined in claim 10 wherein the means for cleaning includes hammers engageable with the screen.

12. The apparatus defined in claim 1 further comprising
means for directing air jets at a downstream face of the screen.

13. The apparatus defined in claim 1, further comprising
a baffle projecting transversely into the fine-particle passage and serving to disperse particles therein.

14. The apparatus defined in claim 1 wherein the air-classifying means includes means for directing jets of air transversely into the fine-fine particle passage.

15. The apparatus defined in claim 3 wherein the air-classifying means includes
a deflector in the fine-particle passage downstream of the screen and upstream of the evacuating fan for diverting flow in the fine-particle passage toward the fan.

16. The apparatus defined in claim 3, further comprising
means movable between a first position directing flow downstream of the evacuating fan from the fine-particle passage into the coarse-particle passage and a second position segregating the passages from each other downstream of the screen.
